(19) United States
(12) Patent Application Publication
(10) Pub. No.: US 2026/0253792 A1
(43) Pub. Date: Aug. 27, 2026

(54) COIL COMPONENT

(71) Applicant: TDK Corporation, Tokyo (JP)

(72) Inventors: Hokuto EDA, Tokyo (JP); Kohei TAKAHASHI, Tokyo (JP); Takahiro NEMOTO, Tokyo (JP); Yuma USAMI, Tokyo (JP); Ryota ISHIKAWA, Tokyo (JP)

(73) Assignee: TDK Corporation, Tokyo (JP)

(21) Appl. No.: 19/535,220

(22) Filed: Feb. 10, 2026

(30) Foreign Application Priority Data
Feb. 21, 2025 (JP) 2025-026576

(51) Int. Cl. H01F 27/29

(52) U.S. Cl. CPC H01F 27/292

(57) ABSTRACT

In a coil component, in a first region of a mounting surface of an element body, a resin component of a resin electrode of a terminal electrode extends into a magnetic powder-containing resin of the element body, and the adhesion between the element body and the terminal electrode including the resin electrode is enhanced by the resin component. In addition, in a region of the mounting surface of the element body, the resin component of the resin electrode does not extend into the element body, and moisture absorption is limited, whereby peeling of the resin electrode from the element body due to moisture absorption is suppressed.

### CROSS-REFERENCE TO RELATED APPLICATIONS

This application is based upon and claims the benefit of priority from Japanese Patent Application No. 2025-26576, filed on 21 February 2025, the entire contents of which are incorporated herein by reference.

### TECHNICAL FIELD

The present disclosure relates to a coil component.

### BACKGROUND

U.S. Patent Application Publication No. 2020/0168387 discloses a coil component in which a coil is disposed within an element body. In the coil component of this document, both ends of the coil are drawn out to a mounting surface of the element body by extraction conductors and are respectively connected to a pair of resin electrodes provided on the mounting surface.

### SUMMARY OF THE INVENTION

In the coil component according to the related art described above, it is conceivable that the resin electrodes may peel from the element body, and if the resin electrodes peel from the element body, a decrease in the mounting strength of the coil may be caused. The inventors, as a result of diligent research, have newly found a technology that can enhance the adhesion of the resin electrodes to the element body.

According to various aspects of the present disclosure, a coil component is provided in which the adhesion of resin electrodes to an element body is improved.

A coil component according to one aspect of the present disclosure includes an element body having a first surface, a coil that is disposed within the element body and includes a pair of extraction conductors exposed from the first surface, an insulating layer that is provided on the first surface and is interposed between regions where the pair of extraction conductors are exposed on the first surface, and a pair of resin electrodes that are provided on the first surface and respectively have a portion covering the regions where the pair of extraction conductors are exposed on the first surface and a portion overlapping the insulating layer, wherein in a first region, which is a region on the first surface other than the regions where the extraction conductors are exposed and the region where the insulating layer is provided, a first resin, which is a resin component of the resin electrodes, extends into the element body.

The inventors have found that when the first resin of the resin electrodes extends into the element body, the adhesion between the element body and the resin electrodes is enhanced by the first resin. In the above coil component, the first resin of the resin electrodes extends into the element body in the first region of the first surface, and the adhesion of the resin electrodes is improved in the first region. However, if the first resin extends into the element body over the entire resin electrodes, the moisture absorption property of the element body increases, and as a result, the resin electrodes are more likely to peel from the element body. In the above coil component, the resin electrodes have a portion that overlaps the insulating layer, and in that portion, the first resin does not extend into the element body, so peeling of the resin electrodes from the element body due to moisture absorption is suppressed.

### BRIEF DESCRIPTION OF THE DRAWINGS

FIG. 1 is a perspective view illustrating a coil component according to an embodiment.

FIG. 2 is a cross-sectional view illustrating the coil component of FIG. 1.

FIG. 3 is an enlarged view of a main part of the coil component of FIG. 2.

FIG. 4 is an enlarged view of a main part of the element body as viewed from the mounting surface side.

### DETAILED DESCRIPTION

Hereinafter, embodiments of the present disclosure will be described in detail with reference to the accompanying drawings. Note that in the description of the drawings, the same or corresponding elements are denoted by the same reference numerals, and redundant description is omitted.

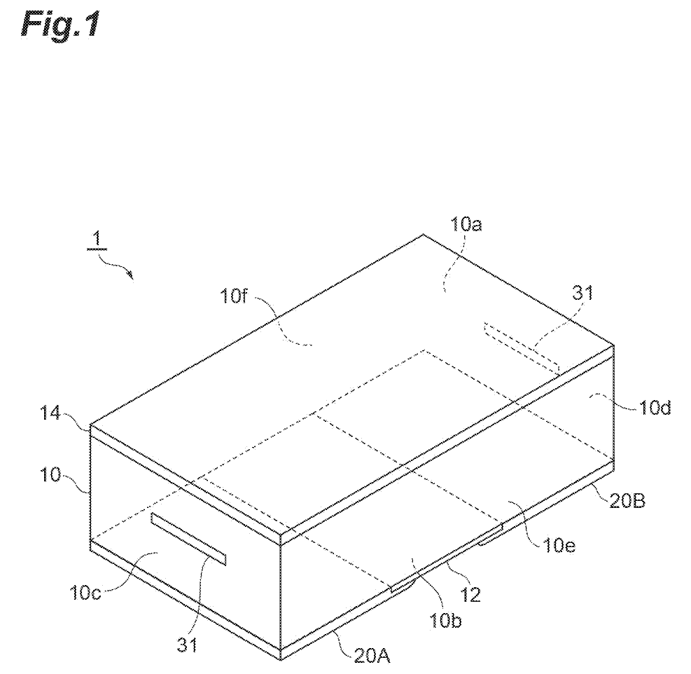

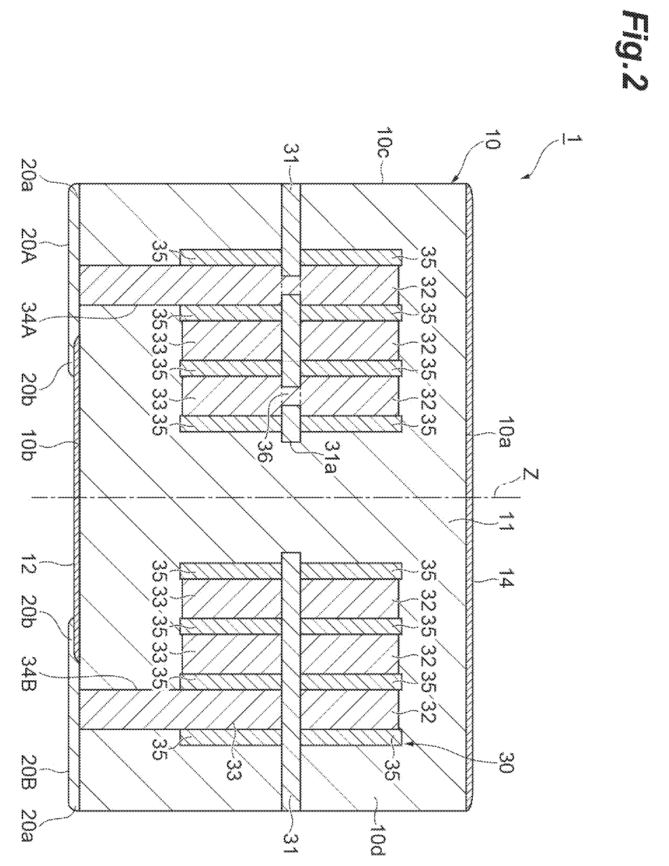

A coil component according to the present embodiment will be described with reference to FIG. 1. As illustrated in FIGS. 1 and 2, a coil component 1 according to an embodiment is configured to include an element body 10, a pair of terminal electrodes 20A and 20B, and a coil 30.

The element body 10 has a rectangular parallelepiped outer shape, and has a pair of main surfaces 10a and 10b parallel to each other, and four side surfaces 10c, 10d, 10e, and 10f connecting the pair of main surfaces 10a and 10b. The rectangular parallelepiped shape in this specification includes a shape of a rectangular parallelepiped in which corner portions and ridge line portions are chamfered, and a shape of a rectangular parallelepiped in which corner portions and ridge line portions are rounded. One main surface 10b (first surface) of the pair of main surfaces 10a and 10b is a surface facing a mounting substrate on which the coil component 1 is mounted, and is also referred to as a mounting surface in the following description. Each of the main surfaces 10a and 10b has a rectangular shape having a long side and a short side, and in the following description, the side surfaces 10c and 10d connecting the short sides of the main surfaces 10a and 10b are also referred to as end surfaces.

The element body 10 is composed of a magnetic powder-containing resin 11, which is a type of magnetic material. The magnetic powder-containing resin 11 is a bonded powder in which magnetic powder, which will be described later, is bound by a binder resin. The binder resin is, for example, a thermosetting epoxy resin. In the present embodiment, the content of the magnetic powder in the bonded powder is 75 to 92 vol% in volume percent, and 95 to 99 wt% in mass percent. From the viewpoint of magnetic properties, the content of the magnetic powder in the bonded powder may be 80 to 92 vol% in volume percent, and 97 to 99 wt% in mass percent.

The magnetic powder of the magnetic powder-containing resin 11 is a mixed powder having a plurality of types of average particle diameters. In the present embodiment, the magnetic powder of the magnetic powder-containing resin 11 constituting the element body 10 is a mixed powder of two types: a first magnetic powder and a second magnetic powder. The magnetic powder of the magnetic powder-containing resin 11 may be included in a range of 50 to 90 parts by weight for the first magnetic powder and in a range of 10 to 50 parts by weight for the second magnetic powder, with respect to 100 parts by weight of the mixed powder. The first magnetic powder can be composed of, for example, an iron-cobalt alloy (FeCo), an iron-silicon alloy (FeSi), an iron-silicon-chromium alloy (FeSiCr), a nanocrystalline alloy, or the like. The average particle diameter of the first magnetic powder is 5 to 40 μm (for example, 25 μm). The second magnetic powder is composed of, for example, an iron-silicon alloy (FeSi), an iron-silicon-chromium alloy (FeSiCr), a Sendust alloy (FeSiAl), Permalloy (FeNi), pure iron (Fe), carbonyl iron, or an amorphous alloy, nanocrystals, or the like. The average particle diameter of the second magnetic powder is 0.1 to 5 μm (for example, 2 μm).

Both of the pair of terminal electrodes 20A and 20B are provided on the mounting surface 10b of the element body 10. The terminal electrode 20A is located on one short side of the mounting surface 10b and has a rectangular shape extending along the short side over the entire length of the short side. The terminal electrode 20B is located on the other short side of the mounting surface 10b and has a rectangular shape extending along the short side over the entire length of the short side.

On the mounting surface 10b of the element body 10, a space between the pair of terminal electrodes 20A and 20B is covered by a covering material 12 (insulating layer). The covering material 12 according to the present embodiment is provided in a rectangular region that extends along the short side direction of the mounting surface 10b and traverses the mounting surface 10b. The covering material 12 is composed of an insulating material such as an epoxy-based resin or an acrylic-based resin.

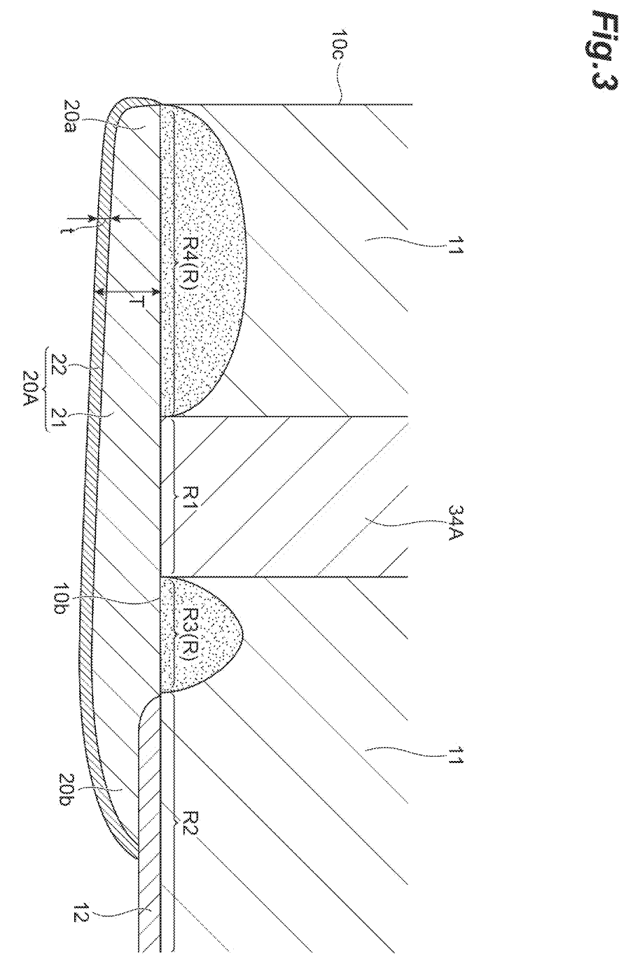

As illustrated in FIG. 3, the terminal electrode 20A extends parallel to the mounting surface 10b, and an end portion 20a on the end surface 10c side is along a short side on the end surface 10c side of the mounting surface 10b. An end portion 20b of the terminal electrode 20A opposite to the end portion 20a on the end surface 10c side is in contact with the covering material 12. Specifically, the end portion 20b of the terminal electrode 20A overlaps an upper side of the covering material 12. That is, the covering material 12 enters under the end portion 20b of the terminal electrode 20A. A portion overlapping the upper side of the covering material 12 is significantly thinner than a portion not overlapping the upper side of the covering material 12. In the present embodiment, the end portion 20b of the terminal electrode 20A gradually becomes thinner toward its tip.

The terminal electrode 20A is configured to include a resin electrode 21 and a conductive layer 22 that entirely covers a surface of the resin electrode 21. The resin electrode 21 is configured to include a metal component (for example, Ag) and a resin component (for example, an epoxy-based resin) and is formed by a printing method. The conductive layer 22 is a plating layer (for example, a Ni plating layer, a Sn plating layer) formed by electrolytic plating, and constitutes a surface of the terminal electrode 20A. The conductive layer 22 may be composed of a single layer or may be composed of a plurality of layers. The conductive layer 22 according to the present embodiment is composed of two layers, a Ni plating layer and a Sn plating layer, arranged in order from the side closer to the resin electrode 21. A thickness T of the terminal electrode 20A is, for example, 5 to 50 μm (for example, 35 μm), and a thickness t of the conductive layer 22 is, for example, 1 to 12 μm (for example, 6 μm).

Note that, regarding the terminal electrode 20B, similarly to the terminal electrode 20A, it extends parallel to the mounting surface 10b, and an end portion 20a on the end surface 10d side is along a short side on the end surface 10d side of the mounting surface 10b. Further, an end portion 20b of the terminal electrode 20B opposite to the end portion 20a on the end surface 10d side is in contact with the covering material 12. Specifically, the end portion 20b of the terminal electrode 20B overlaps an upper side of the covering material 12. Also, in the terminal electrode 20B, similarly to the terminal electrode 20A, a portion overlapping the upper side of the covering material 12 is significantly thinner than a portion not overlapping the upper side of the covering material 12. In the present embodiment, the end portion 20b of the terminal electrode 20B gradually becomes thinner toward its tip. The terminal electrode 20B, similarly to the terminal electrode 20A, is configured to include a resin electrode 21 and a conductive layer 22 that entirely covers a surface of the resin electrode 21. The dimensions and shape of the terminal electrode 20B may be the same as or different from the dimensions and shape of the terminal electrode 20A.

In this way, by interposing the covering material 12 between the pair of terminal electrodes 20A and 20B, a short circuit between the pair of terminal electrodes 20A and 20B is prevented.

The main surface 10a of the element body 10 is entirely covered by a covering material 14. That is, the entire region of the main surface 10a covered by the covering material 14 is not exposed to the outside. The covering material 14 is composed of an insulating material such as an epoxy-based resin or an acrylic-based resin. A constituent material of the covering material 14 that covers the main surface 10a may be the same as or different from a constituent material of the covering material 12 that covers the mounting surface 10b.

The coil 30 is disposed within the element body 10, as illustrated in FIG. 2. The coil 30 according to the present embodiment is wound around a coil axis Z extending in a direction orthogonal to the mounting surface 10b. The coil 30 is configured to include an insulating substrate 31, planar coils 32 and 33 provided on both surfaces of the insulating substrate 31, and a pair of extraction conductors 34A and 34B.

The insulating substrate 31 extends parallel to the mounting surface 10b, and can be disposed, for example, at an intermediate position between the mounting surface 10b and the main surface 10a. The insulating substrate 31 has a through-hole 31a at a position through which the coil axis Z passes. The insulating substrate 31 reaches the end surfaces 10c and 10d and is exposed from the end surfaces 10c and 10d. The insulating substrate 31 may reach the four side surfaces 10c, 10d, 10e, and 10f and be exposed from the four side surfaces 10c, 10d, 10e, and 10f, or may be exposed only from the end surfaces 10c, and 10d. For the insulating substrate 31, a substrate in which a glass cloth is impregnated with a cyanate resin (BT (bismaleimide-triazine) resin: registered trademark) can be used. In addition, polyimide, aramid, epoxy, or the like can also be used in addition to BT resin. As a material for the insulating substrate 31, ceramic or glass can also be used. As the material for the insulating substrate 31, a mass-produced printed circuit board material can be used, and a resin material used for a BT printed circuit board, an FR4 printed circuit board, or an FR5 printed circuit board can be used.

The planar coil 32 is wound for a plurality of turns around the coil axis Z on a surface of the insulating substrate 31 on the main surface 10a side. An inner turn and an outer turn of the planar coil 32 are separated by a resin wall 35 provided on the insulating substrate 31. The planar coil 33 is wound around the coil axis Z on a surface of the insulating substrate 31 on the mounting surface 10b side. An inner turn and an outer turn of the planar coil 33 are also separated by a resin wall 35 provided on the insulating substrate 31, similarly to the planar coil 32.

The planar coil 32 and the planar coil 33 are connected to each other at their inner peripheral ends via a via conductor 36 provided at an edge of the through-hole 31a of the insulating substrate 31. An outer peripheral end of the planar coil 32 overlaps with the terminal electrode 20A when viewed from the main surface 10a side of the element body 10, and is connected to the terminal electrode 20A via an extraction conductor 34A extending inside the element body 10 in a direction orthogonal to the mounting surface 10b.

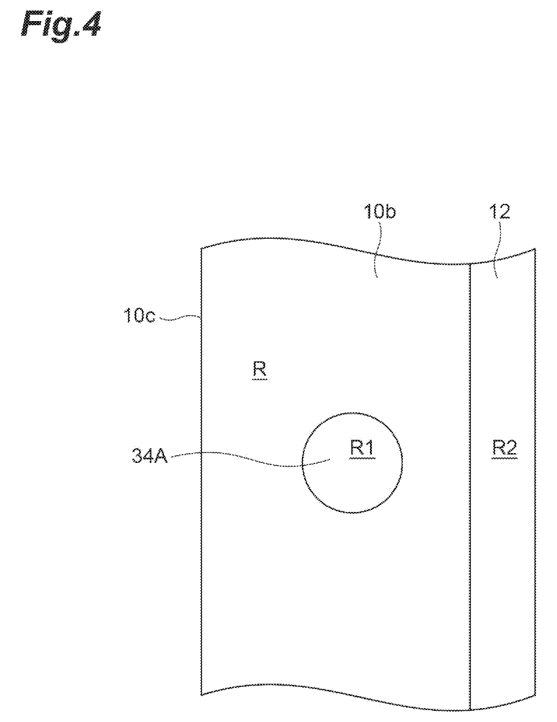

In the present embodiment, as illustrated in FIG. 4, a region where the extraction conductor 34A is exposed has a perfect circle shape when viewed from the mounting surface 10b side of the element body 10. Note that the region where the extraction conductor 34A is exposed is not limited to a perfect circle shape, and may be an elliptical shape, a polygonal shape, or a rounded polygonal shape. The terminal electrode 20A integrally covers the region where the extraction conductor 34A is exposed and its surrounding region on the mounting surface 10b, and more specifically, the resin electrode 21 of the terminal electrode 20A integrally covers the region where the extraction conductor 34A is exposed and its surrounding region.

An outer peripheral end of the planar coil 33 overlaps with the terminal electrode 20B when viewed from the main surface 10a side of the element body 10, and is connected to the terminal electrode 20B via an extraction conductor 34B extending inside the element body 10 in a direction orthogonal to the mounting surface 10b. Note that, regarding the extraction conductor 34B, it has the same or a similar form as the extraction conductor 34A, and the terminal electrode 20B integrally covers the region where the extraction conductor 34B is exposed and its surrounding region on the mounting surface 10b, and more specifically, the resin electrode 21 of the terminal electrode 20B integrally covers the region where the extraction conductor 34B is exposed and its surrounding region.

The planar coil 32 and the planar coil 33 are wound such that current flows in the same direction (that is, the same winding direction when viewed from the main surface 10a side of the element body 10) when a voltage is applied between the pair of terminal electrodes 20A and 20B. Since current flows in the same direction in the planar coil 32 and the planar coil 33, generated magnetic fluxes are superimposed and reinforce each other.

In the coil component 1 described above, as illustrated in FIG. 3, in a first region R, which is a region on the mounting surface 10b other than a region R1 where the extraction conductors 34A and 34B are exposed and a region R2 where the covering material 12 is provided, the resin electrodes 21 of the terminal electrodes 20A and 20B are in direct contact with the magnetic powder-containing resin 11 of the element body 10 that constitutes the mounting surface 10b. In the present embodiment, the first region R surrounds the region R1 where the extraction conductors 34A and 34B are exposed on the mounting surface 10b, as illustrated in FIG. 4. Further, the first region R includes a region R3 that is a region adjacent to the region R1 on the covering material 12 side (the right side in FIG. 3) with respect to the region R1 where the extraction conductors 34A and 34B are exposed on the mounting surface 10b, and is sandwiched between the region R1 where the extraction conductors 34A and 34B are exposed on the mounting surface 10b and the region R2 where the covering material 12 is provided. Furthermore, the first region R includes a region R4 adjacent to the region R1 on the end surface side (the left side in FIG. 3) with respect to the region R1 where the extraction conductors 34A and 34B are exposed on the mounting surface 10b. Then, in the first region R, a resin component (first resin) of the resin electrodes 21 of the terminal electrodes 20A and 20B extends into the magnetic powder-containing resin 11 of the element body 10, and the adhesion between the element body 10 and the terminal electrodes 20A and 20B including the resin electrodes 21 is enhanced by the resin component.

An amount of the resin component of the resin electrode 21 that penetrates into the element body 10 in the region R3 of the first region R may be the same as or different from an amount of the resin component of the resin electrode 21 that penetrates into the element body 10 in the region R4. In the present embodiment, the amount of the resin component of the resin electrode 21 that penetrates into the element body 10 in the region R3 is greater than the amount of the resin component of the resin electrode 21 that penetrates into the element body 10 in the region R4. Further, a length (depth) to which the resin component of the resin electrode 21 penetrates into the element body 10 in the region R3 is also longer than a length to which the resin component of the resin electrode 21 penetrates into the element body 10 in the region R4. The length to which the resin component of the resin electrode 21 penetrates into the element body 10 in the regions R3 and R4 may be, for example, about 1/4 of the length of the extraction conductors 34A and 34B.

Since the resin existing in the element body 10 increases the moisture absorption property of the element body 10, if the entire resin electrode 21 is in direct contact with the mounting surface 10b and the resin component extends into the element body 10 from the entire resin electrode 21, the moisture absorption property of the element body 10 becomes excessively high, and as a result, the resin electrode 21 may peel from the element body 10 due to moisture absorption of the element body 10. In the coil component 1, since the end portions 20b of the terminal electrodes 20A and 20B overlap the covering material 12, in the region R2 where the covering material 12 is provided, the resin electrode 21 at the end portion 20b is not in direct contact with the magnetic powder-containing resin 11 that constitutes the mounting surface 10b. In other words, the resin electrodes 21 of the terminal electrodes 20A and 20B have both a portion that is in direct contact with the magnetic powder-containing resin 11 constituting the mounting surface 10b (a portion corresponding to the first region R) and a portion that is not in direct contact with the magnetic powder-containing resin 11 constituting the mounting surface 10b (a portion corresponding to the region R2). Then, the resin component of the resin electrode 21 at the end portion 20b that is not in direct contact with the magnetic powder-containing resin 11 constituting the mounting surface 10b does not extend into the element body 10, and moisture absorption is limited at the end portion 20b, whereby peeling of the resin electrode 21 from the element body 10 due to moisture absorption is suppressed. At this time, the resin component of the resin electrode 21 is substantially not present in the region R2 where the covering material 12 is provided, and the amount of the resin component of the resin electrode 21 in the first region R is greater than the amount of the resin component of the resin electrode 21 in the region R2 where the covering material 12 is provided.

In the coil component 1, the surface roughness of the first region R on the mounting surface 10b may be rougher than the surface roughness of the region R2 where the covering material 12 is provided. In this case, the resin component of the resin electrode 21 is more likely to penetrate into the element body 10 in the first region R, and further improvement in the adhesion between the element body 10 and the terminal electrodes 20A and 20B including the resin electrode 21 is achieved. For example, by selectively performing a wet etching process only on the mounting surface 10b of the first region R and not performing a wet etching process on the mounting surface 10b of the region R2 where the covering material 12 is provided, the surface roughness of the first region R can be made rougher than the surface roughness of the region R2 where the covering material 12 is provided.

In the present embodiment, the terminal electrodes 20A and 20B have a maximum thickness T in a portion corresponding to the region R3, and the resin electrodes 21 of the respective terminal electrodes 20A and 20B gradually become thinner as the distance from the region R3 increases. That is, the resin electrode 21 of each of the terminal electrodes 20A and 20B gradually becomes thinner toward the tip of the end portion 20a, and also gradually becomes thinner toward the tip of the end portion 20b.

The present disclosure is not limited to the embodiments described above, and can be variously modified. For example, the magnetic powder of the magnetic powder-containing resin constituting the element body of the coil may be a mixed powder of three or more types of magnetic powders having different average particle diameters. The coil is not limited to the form described above, and may be, for example, a form that does not include a substrate. Further, the coil may be wound around a coil axis parallel to the mounting surface.

What is claimed is:

1. A coil component comprising:
an element body having a first surface;
a coil disposed in the element body and including a pair of extraction conductors exposed from the first surface;
an insulating layer provided on the first surface and interposed between regions where the pair of extraction conductors are exposed on the first surface; and
a pair of resin electrodes provided on the first surface and respectively having a portion covering the regions where the pair of extraction conductors are exposed on the first surface and a portion overlapping the insulating layer,
wherein a first resin extends into the element body in a first region, the first region is a region on the first surface other than the regions where the extraction conductors are exposed and the insulating layer is provided, the first resin is a resin component of the resin electrodes.

2. The coil component according to claim 1, wherein the first region includes a region sandwiched between the region where the extraction conductor is exposed on the first surface and the region where the insulating layer is provided.

3. The coil component according to claim 1, wherein an amount of the first resin in the first region is greater than an amount of the first resin in the region where the insulating layer is provided.

4. The coil component according to claim 1, wherein a surface roughness in the first region is rougher than a surface roughness of the region where the insulating layer is provided.

5. The coil component according to claim 1, wherein the first region includes a region adjacent to the region where the extraction conductors are exposed on the first surface on a side of the insulating layer, and a region adjacent to the region where the extraction conductors are exposed on a side opposite to the side of the insulating layer, and
an amount of the first resin is greater in the region adjacent to the region where the extraction conductors are exposed on the first surface on the side of the insulating layer.

6. The coil component according to claim 1, wherein the first region surrounds the region where the extraction conductor is exposed, when viewed from a side of the first surface of the element body.

7. The coil component according to claim 1, wherein end portions of the pair of resin electrodes closer to each other gradually become thinner toward tips thereof.

8. The coil component according to claim 1, wherein end portions of the pair of resin electrodes farther from each other gradually become thinner toward tips thereof.
